(19) United States
(12) Patent Application Publication
(10) Pub. No.: US 2013/0304507 A1
(43) Pub. Date: Nov. 14, 2013

(54) CLINICAL NOTE GENERATOR

(71) Applicant: Valant Medical Solutions, Inc., (US)

(72) Inventors: Aaron Christopher Dail, Seattle, WA (US); David Ho Lischner, Seattle, WA (US); Ronald Lincoln Addison Theis, Seattle, WA (US)

(73) Assignee: Valant Medical Solutions, Inc., Seattle, WA (US)

(21) Appl. No.: 13/865,074

(22) Filed: Apr. 17, 2013

Related U.S. Application Data
(60) Provisional application No. 61/636,503, filed on Apr. 20, 2012.
(60) Provisional application No. 61/789,174, filed on Mar. 15, 2013.

(51) Int. Cl. G06F 19/00

(52) U.S. Cl. CPC G06F 19/322
USPC 705/3

(57) ABSTRACT

Automation of clinical note generation is provided. A narrative generation system is provided which enables creation, storage, and editing of digital representations of paper measures. The note generation system may further enable rules to be established which specify the manner in which a narrative is generated for a given patient measure based upon the completed patient measures. When a clinical note is to be generated for the completed patient measure, the patient measure may be retrieved and analyzed by the note generation system according to the rules. The note generation system may further output the generated narrative in clinical notes displaying the completed patient measures and generated narrative for review and editing, as necessary, by a clinician.

### BACKGROUND

In medical practice, clinicians customarily document the physical and/or mental health of a patient at each stage of treatment with clinical notes. The clinical notes may include a comprehensive, written description of one or more of the patient's history, such as the reason the patient was referred to the clinician, patient information such as age, gender, the patient's current medical complaint/issue, the recommended course of treatment, and the outcome of the recommended treatment (e.g., the patient's condition). In this manner, the clinical notes provide so physicians and others participating in the patient's care a complete picture of the patient, their condition, and course of treatment, both in the past and present. Furthermore, the clinical notes generated for a patient may be necessary for billing a patient's medical insurance.

While the importance of maintaining patient clinical notes is well understood, the process of regularly preparing clinical notes can be difficult for a clinician. For example, preparing clinical notes may be time consuming, tedious, and/or labor intensive.

### BRIEF DESCRIPTION OF THE DRAWINGS

The foregoing aspects and many of the attendant advantages will become more readily appreciated as the same become better understood by reference to the following detailed description, when taken in conjunction with the accompanying drawings, where:

FIG. 1 is a schematic block diagram depicting an illustrative clinical note generation system;

FIG. 2 is a schematic flow chart depicting an illustrative process for generating clinical notes using the system of FIG. 1;

FIGS. 3A-3B depict an illustrative user interface displayed on a medical administrator's computing device that enables entry of information for preparing an electronic measure and a preview of the electronic measure so prepared;

FIG. 4 depicts another illustrative user interface displayed on the medical administrator's computing device that enables the administrator to specify rules for generating the narrative for clinical notes based upon the patient's responses recorded in the electronic measure;

FIG. 5 depicts an illustrative user interface displayed on a patient's computing device that enables a patient to respond to questions regarding their condition; and

FIGS. 6A-6B depict an illustrative user interface displayed on a clinician's computing device that enables the clinician to review the patient's completed measure, review the clinical notes generated by the system of FIG. 1, and edit the clinical notes.

### DETAILED DESCRIPTION

Generally described, aspects of the present disclosure relate to generating narratives for clinical notes. More specifically an electronic clinical note generation system is provided that enables automatic generation of clinical notes, including narratives, based upon completed patient outcome measures. The clinical note generation system may further enable review and/or editing of the generated clinical notes by a clinician.

As discussed in greater detail below, embodiments of the narrative generation system may provide user interfaces which enable creation, storage, and editing of digital representations of clinical measures. The clinical measures may be any question, symptom, feeling, diagnosis, physiological parameter, self-reported observation, or physician or clinician observation which pertains to a condition of the patient. Clinical measures may be presented to the patient in the form of questions or surveys which can be answered or filled out by a patient at home, in a waiting room, or during a session or visit with a clinician. In some embodiments, healthcare providers may designate specific measures as requiring answers from specific patients, the specified measures may be sent to the specified patients via a network portal, and the patients may fill in the measures and return the responses via the network portal. Some embodiments may be a paper questionnaire or survey, the results of which may be manually entered or scanned into a digital patient file by a clinician or assistant. Other embodiments of the questionnaire or survey may be digitized and may be filled out by a patient on a computing device. Patient responses to the clinical measures may include self-reported binary ratings, scale ratings, checked symptoms, and/or text. Digital patient responses to clinical measures may be stored in a database in association with the patient or the patient's file. These measures may be useful to include in clinical notes.

The note generation system may further enable rules to be set-up which specify the manner in which the narrative is generated for a given measure based upon the patient's responses. Digitized or digital patient responses to clinical measures may be subsequently retrieved and analyzed by the note generation system in order to generate narratives according to the rules. The note generation system may further generate clinical notes that display both the completed patient measures and generated narrative for review and editing, as necessary, by a clinician. Some embodiments of the note generation system may prompt a healthcare provider or clinician for review of a draft narrative when the provider starts a new progress note for a patient. Although the embodiments are discussed in the context of clinical measures, also referred to as patient measures, it will be appreciated that the generated notes may also include information regarding patient test results, physical parameter measurements, or any other data generated during care of a patient which may be useful to store in a clinical note, as well as a combination of various types of information about the patient.

Beneficially, the clinical note generation system may enable the time and expertise of clinicians to be used efficiently in preparation of clinical notes. For example, in general, there are accepted conventions for describing patient outcomes for a given patient measure. It is decidedly inefficient for a clinician to spend their time documenting routine observations. Accordingly, using the note generation system, a non-clinician, such as a medical administrator, may input rules for generating clinical note narratives which conform to the accepted conventions for describing patient outcomes for a given patient measure.

Subsequently, a clinician, when preparing a clinical note, may begin this process by using the note generation system to access a draft prepared by the system. The draft may include the completed patient measure and a proposed narrative based upon these accepted conventions. The clinician may further edit the draft clinical note appropriately prior to approval. In this manner, routine and generally accepted observations based upon the patient measure may be automatically entered into the narrative of the draft clinical note. In the case where these general conventions are appropriate and accurately capture the patient outcome, the clinician may quickly review and approve the clinical note. Alternatively, in the case where one or more of these general conventions is not appropriate or fails to accurately capture a patient outcome, or the clinician desires to add their own comments, the clinician may employ the note generation system to edit the narrative of the draft clinical note as necessary. In either case, the note generation system allows a clinician to spend the majority of their time preparing a clinical note on value-added tasks, such as review and/or adding comments which are beyond the routine, rather than merely documenting routine observations.

Embodiments discussed below may refer to generation of narratives for clinical notes from patient measures, such as patient responses to questions. However, it may be understood that narratives may be generated from any computer-readable patient information accessible by the note generation system.

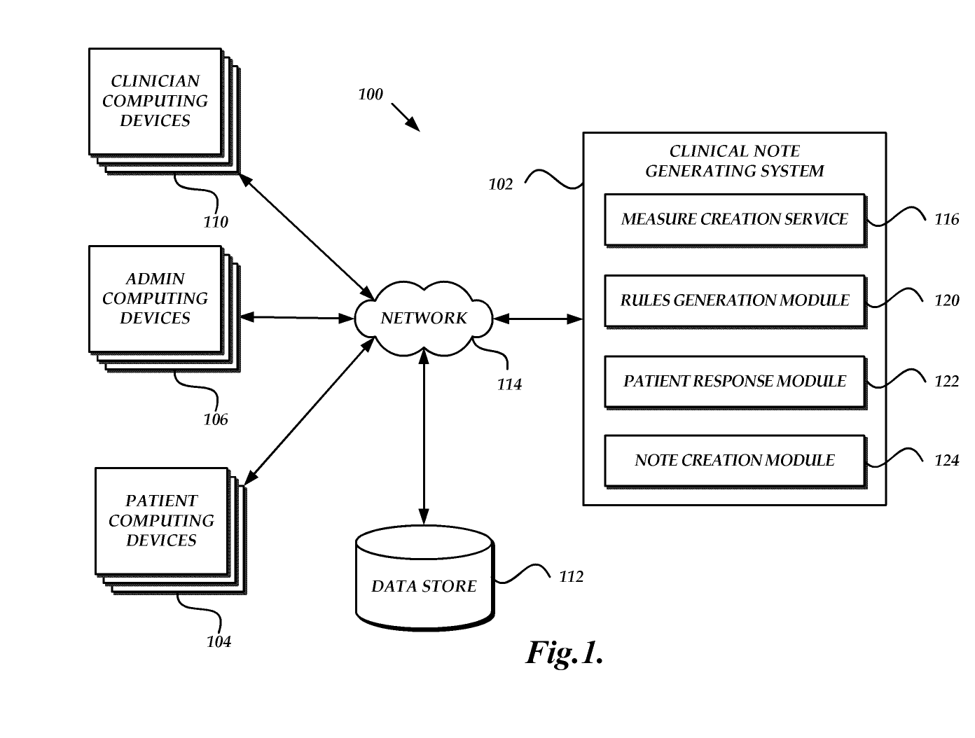

With reference to FIG. 1, a block diagram depicting an illustrative operating environment 100 is shown which includes a clinical note generating module 102 that enables automatic generation of narratives for clinical notes based upon completed patient measures. The operating environment 100 includes one or more computing devices in communication with the note generation system 102 via a network 114. The computing devices may include patient computing devices 104, administrator computing devices 106, and clinician computing devices 110. The operating environment may further include one or more data stores 112.

The computing devices 104, 106, 110 may be any computing device, such as personal computer (PC), kiosk, thin client, home computer, and dedicated or embedded machine. Further examples may include a laptop or tablet computers, servers, personal digital assistant (PDA), hybrid PDA/mobile phones, mobile phones, electronic book readers, set-top boxes, cameras, digital media players, and the like.

Those skilled in the art will appreciate that the network 114 may be any wired network, wireless network, or combination thereof. In addition, the network 114 may be a personal area network, local area network, wide area network, cable network, satellite network, cellular telephone network, or combination thereof. In the illustrated embodiment, the network 114 is the Internet. Protocols and components for communicating via the Internet or any of the other aforementioned types of communication networks are well known to those skilled in the art of computer communications and thus, need not be described in more detail herein.

The clinical note generating system is illustrated in FIG. 1 operating in a distributed computing environment comprising several computer systems that are interconnected using one or more networks. More specifically, the clinical note generating system 102 may include a measure creating module 116, a rules generation module 120, a patient response module 122, and a note creation module 124, discussed in greater detail below. However, it may be appreciated by those skilled in the art that the clinical note generating system 102 may have fewer or greater components than are illustrated in FIG. 1. In addition the clinical note generating system 102 could include various Web services and/or peer-to-peer network configurations. Thus, the depiction of the clinical note generating system 102 in FIG. 1 should be taken as illustrative and not limiting to the present disclosure.

Any one or more of the measure creating module 116, the rules generation module 120, the patient response module 122, and the note creation module 124 may be embodied in a plurality of components, each executing an instance of the respective measure creating module 116, the rules generation module 120, the patient response module 122, and the note creation module 124. A server or other computing component implementing any one of the measure creating module 116, the rules generation module 120, the patient response module 122, and the note creation module 124 may include a network interface, memory, processing unit, and computer readable medium drive, all of which may communicate which each other may way of a communication bus. The network interface may provide connectivity over the network 114 and/or other networks or computer systems. The processing unit may communicate to and from memory containing program instructions that the processing unit executes in order to operate the respective measure creating module 116, rules generation module 120, patient response module 122, and note creation module 124. The memory may generally include RAM, ROM, and/or other persistent and auxiliary computer-readable media.

The data store 112 may include any data storage device understood in the art, including, but not limited to, magnetic, optical, and solid-state data storage devices. The data store 112 may be further embodied in one or more data storage devices. These data storage devices may be accessible over the network and/or may be local to one or more of the clinical note generating system and the computing devices 104, 106, 110.

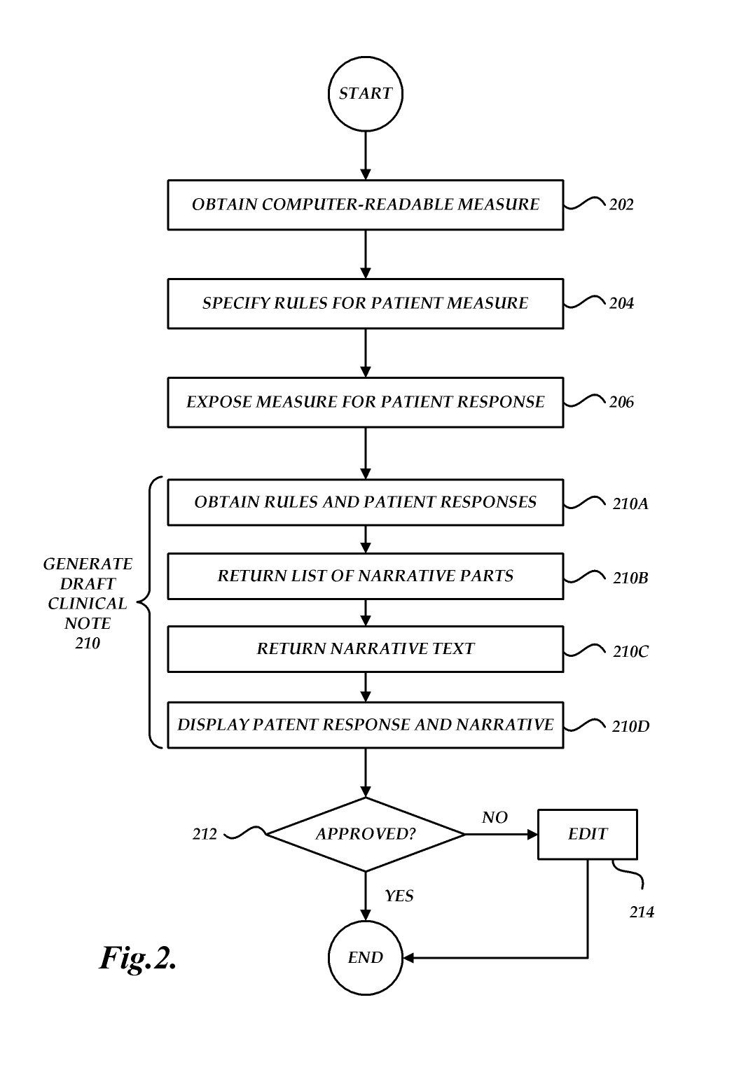

FIG. 2 illustrates a flow diagram illustrating an embodiment of a process 200 employed by the clinical note generating system 102 for generating clinical notes from completed patient measures. For example, in block 202, a computer readable measure may be obtained. In block 204, rules for generating a narrative from the patient measure may be specified. In block 206, the measure may be exposed to a patient for response. In block 210, a draft clinical note may be generated. The generated draft clinical note may be reviewed, edited, and approved by a clinician in blocks 214-216. It may be understood that the process 200 may include greater or fewer blocks than illustrated in FIG. 2 and the blocks may be performed in a different order than illustrated in FIG. 2, as necessary. Use of the clinical note generating system 102 (i.e., any of the measure creating module 116, the rules generation module 120, the patient response module 122, and the note creation module 124) by the computing devices 104, 106, and 110 for preparation of clinical notes will now be discussed.

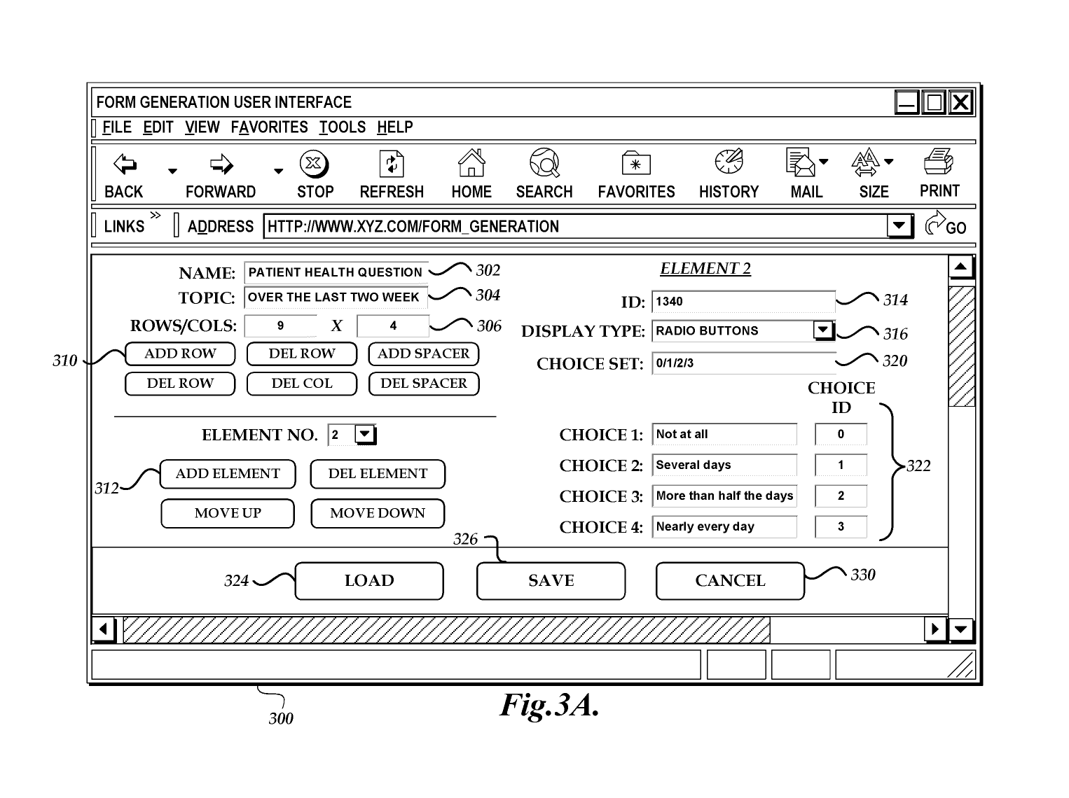

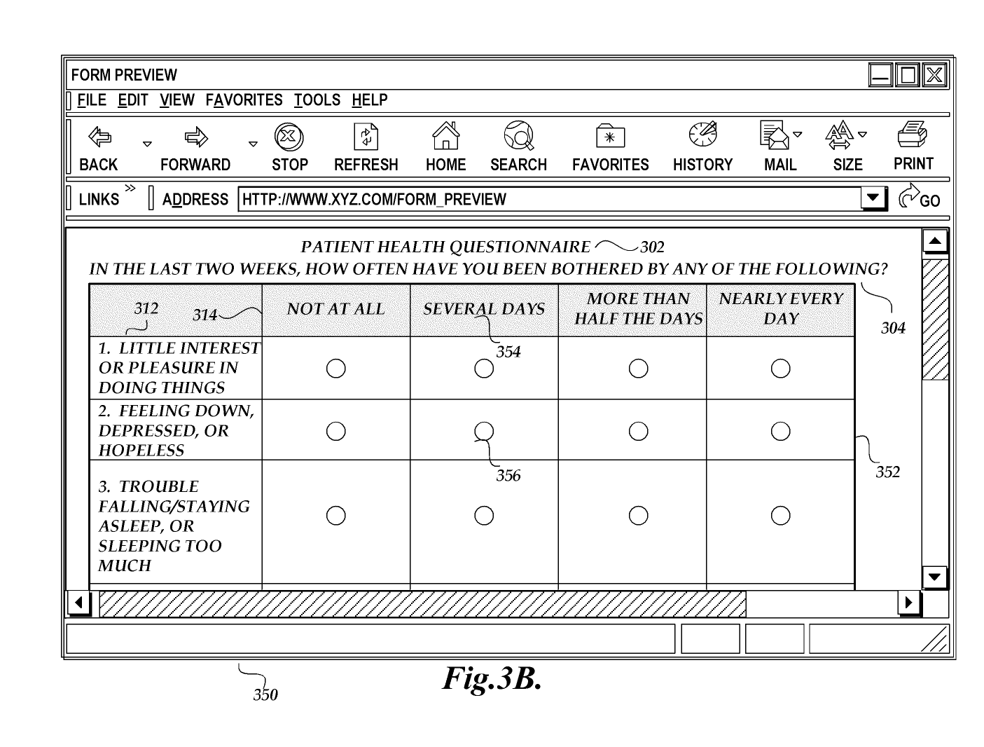

In block 202, a computer-readable measure is obtained by the measure creating module 116 at the request of an authorized user of the note generating system 102. In one embodiment, the measure creating module 116 may provide a user interface, as described in greater detail below with respect to FIGS. 3A-3B, enables the authorized user to create a patient measure. In another embodiment, the measure creating module 116 may be obtained from a data storage device (i.e., the data store 112).

For example, the authorized user may be a medical administrator employing his or her administrator computing device 106 to communicate with the clinical note generating system 102. The administrator may be one or more individuals authorized to prepare patient measures. Examples may include, but are not limited to, non-clinicians such as medical administrators or information technology staff, as well as clinicians such as nurses, physicians, counselors, and other clinical professionals.

With reference to FIG. 3A, a user interface 300 that enables an authorized user to create a computer-readable (e.g., digital) version of a paper measure is illustrated. The user interface 300 includes a plurality of formatting user interface objects 302-310 which allow the user to specify the formatting of the patient measure and a plurality of user interface objects 312-322 that allow the user to specify the elements of the patient measure which are subsequently used by the clinical note generation system 102 to generate the narrative. User interface 300 may additionally include user interface objects 324-326 for use in loading, saving, and deleting a digital patient measure.

The formatting user interface objects 302-310 may include a name field 302, a topic field 304, a rows/cols field 306, and formatting options 310. The name field 302 may enable the user to specify the name of the patient measure, including a name for the patient measure which is exposed to the administrator (e.g., a trade name or code name) as well as an informal name to be exposed to the patient. The topic field 304 may enable the user to specify an overall topic for which specific questions will be asked. The rows/cols field 306 may enable the user to specify of the number of rows and columns which are to be displayed in the patient measure. The formatting options 310 further enable the user to add or delete rows, columns, and spacers from the patient measure.

Each element may include an ID, a display type, and optionally, a choice set. The ID is immutable and uniquely identifies an element throughout the note generation system 102. The display type represents how the element is displayed. Options may include static text that the patient cannot enter or input elements which the patient may use to input a response. For example, input elements may include multiple-choice lists (e.g., a group of radio buttons where each radio button represents a single option the patient can select) or free-form elements (e.g., a text box where the user can type in anything).

The element user interface objects 312 allow the user to add, delete, and select elements, as well as to move a selected element up or down as compared to other elements. After an element is selected, user interface objects 314-322 enable the user to specify the parameters of the selected element. The ID field 314 may enable the user to enter the ID for the element. The display type field 316 may enable the user to enter the display type for the element. The choice set field 320 may enable the user to specify a choice set for the element. In the circumstance where a choice set is specified in the choice set field 320, the user may employ choice fields 322 to specify the patient selectable choices and designate choice IDs which are used to represent the respective choices.

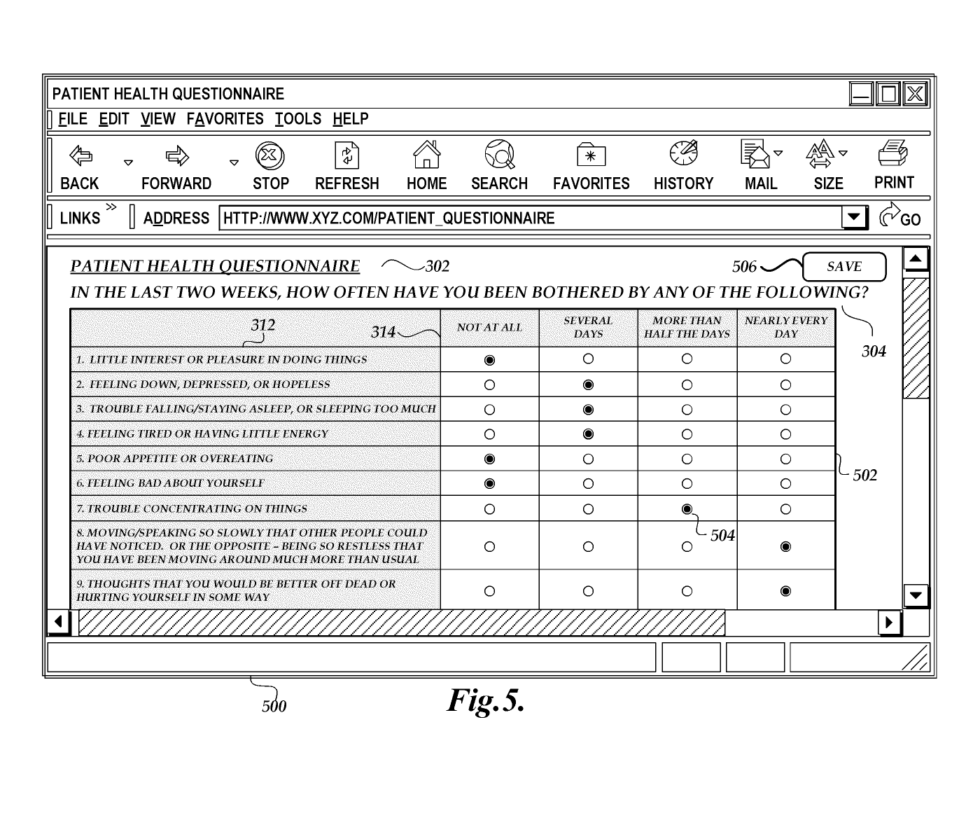

FIG. 3B illustrates an embodiment of a user interface 350 which displays a preview of the patient measure corresponding to the parameters entered in the user interface 300 of FIG. 3A. For example, the user interface 350 displays general information regarding the patient measure, such as the informal name of patent measure 302, “Patient Health Questionnaire” and topic 304, “In the last two weeks, how often have you been bothered by any of the following?” The user interface 350 further includes the elements in a table 352. For example, assume that element 1 corresponds to the static text, “1. Little or no interest or pleasure in doing things,” in the first column of the table 352. Element 2, specified in user interface objects 314-322 as a multiple choice set with 4 options selectable by radio buttons, is displayed next to Element 1 in the remaining columns of the table. For example, option text 356 (e.g., “not at all,” “several days,” “more than half the days,” and “nearly every day” is displayed in the row of the table above Element 1. The radio buttons 356 corresponding to the option text are displayed to the immediate right of Element 1. An example of a completed patient measure is illustrated in FIG. 5.

Returning to FIG. 2, in block 204 of process 200, rules are specified by which the narrative is composed when a patient fills out the clinical measure. For example, the administrator, employing his or her administrator computing device 106, may communicate with the rules generation module 120 via a user interface which enables an administrator to enter rules specific to a given digital patient measure. It may be understood that the administrator specifying the rules for a patient measure may be the same or different from an administrator who has created the digital patient measure.

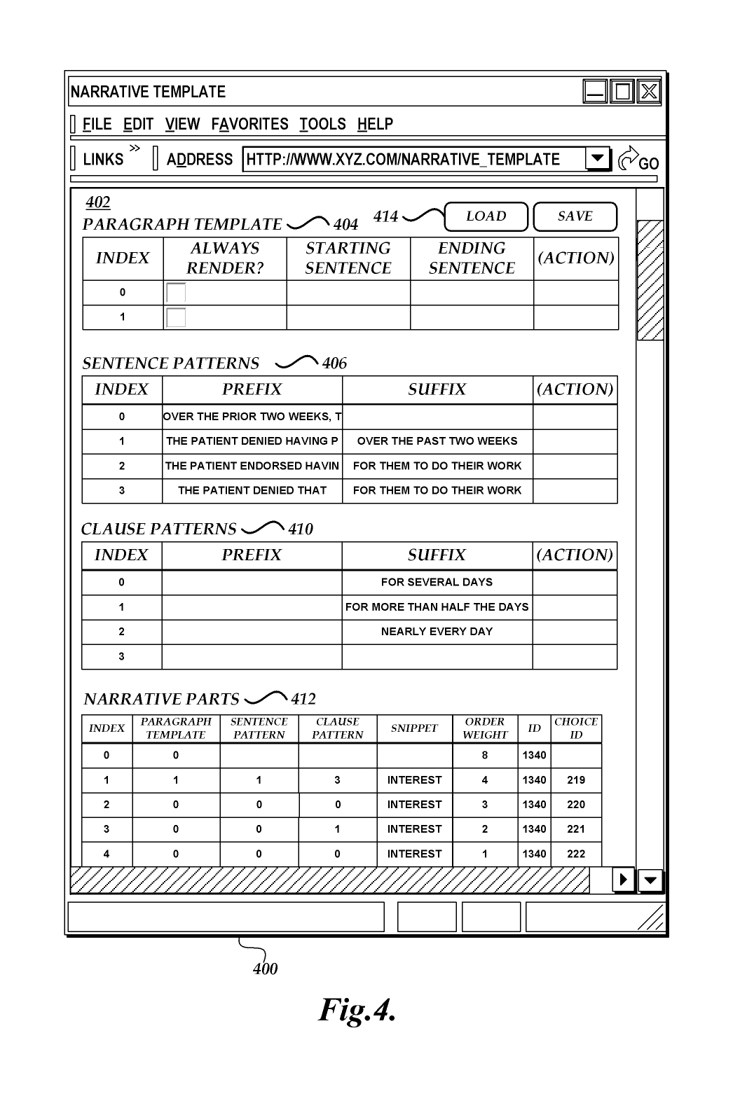

FIG. 4 illustrates a user interface 400 provided by the rules generation module 120 to facilitate interaction between the administrator and the clinical note generation system 102 for generation of draft narratives (e.g., narrative templates). The user interface 400 may include a narrative template 402 separated into an ordered hierarchy of components, including, but not limited to (from highest to lowest in the hierarchy), paragraph templates 404, sentence patterns 406, and clause patterns 410. The narrative template 402 may include a further component, narrative parts 412, which are used to assemble the paragraph templates 404, sentence patterns 406, and clause patterns 410 into the narrative. User interface components 414 may be further provided for loading and saving narrative templates for a patient measure.

The narrative parts 412 may represent all possible pieces of narrative that may be composed into a narrative regarding the patient measure. Each narrative part 412 may include a snippet of text that will go into the narrative, an order weight, a reference to the paragraph template the narrative part 412 is associated with, and optional references to the sentence pattern 404 and clause pattern 410 used by the narrative part 412. For each freeform-input element in the patient measure, a narrative part 412 may be included in the narrative template. For each element having multiple-choices in the patient measure, a narrative part may be included for each choice in the narrative template. For multiple choice input elements in the patient measure, an additional “not answered” the narrative part may be included in the narrative template to cover the circumstance where the patient did not provide an answer.

The narrative parts 412 may further include narrative part selection rules. A selection rule is provided for every narrative part in the narrative template. These rules instruct the note generation system to include a specific narrative part 412 when the patient provides a specific answer to a specific question in a given patient measure.

One or more paragraph templates 404 are included in the narrative template, where each paragraph template 404, when present, includes an optional starting sentence, an optional ending sentence, an order, and a flag indicating whether the paragraph is always rendered as part of the narrative. A paragraph grouping is provided for each paragraph template in the narrative template 402. Each paragraph grouping includes the paragraph template to which it belongs and one of a narrative part and a sentence grouping for the paragraph grouping.

The sentence patterns 406 may be optionally included in the narrative template. When present, the sentence patterns 406 may include an optional sentence prefix and optional sentence suffix. A sentence grouping is provided for each sentence pattern 406 in the narrative template 402. Each sentence grouping includes the sentence pattern 406 to which it belongs and a one of a narrative part and a clause grouping for the sentence grouping.

The clause patterns 410 may be optionally included in the narrative template. When present, the clause patterns 410 may include an optional clause prefix and optional clause suffix. A clause grouping is provided for each clause pattern 410 in the narrative template 402. Each clause grouping includes the clause pattern 410 to which it belongs and a list of narrative parts for the clause grouping).

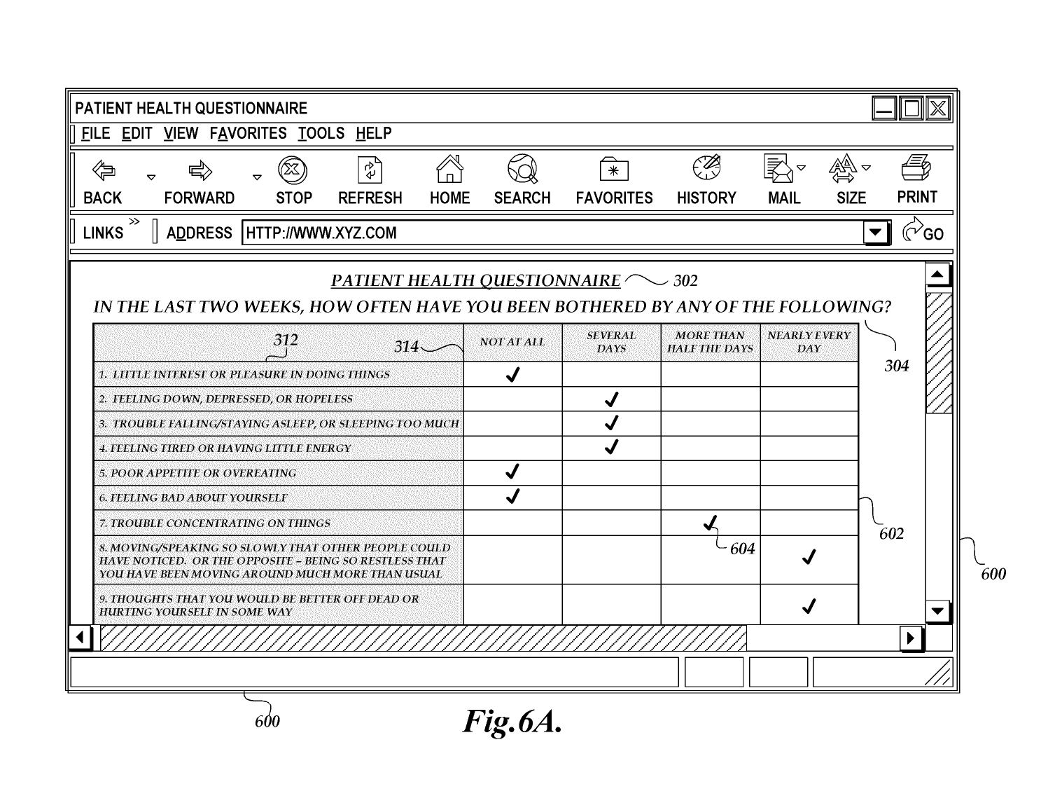

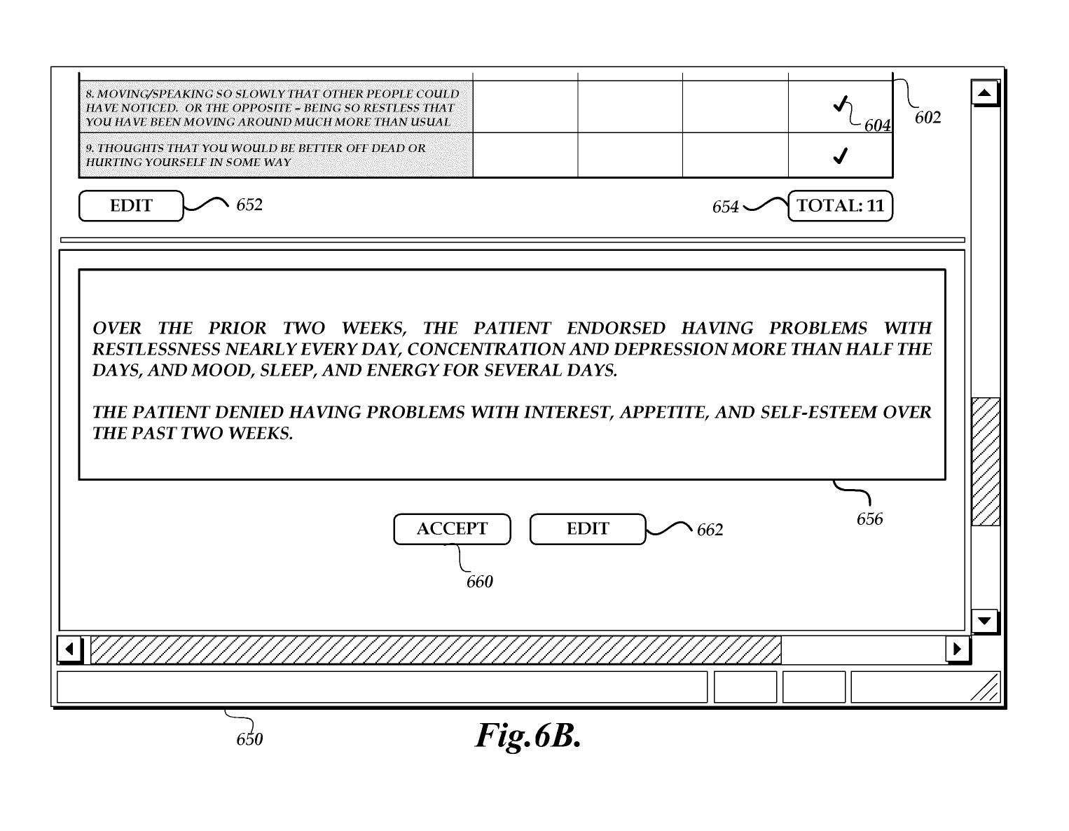

So configured, the user interface 400 combines editing of narrative parts and narrative part selection rules. The narrative part selection rules are handled globally by the system and are not editable by the administrator. For example, assuming the narrative template of FIG. 3A, including an element with four radio button group choices, the administrator will be presented with five narrative part rows related to this question (four for choices and one more for capturing when the patient did not make a choice). The paragraph template 404, sentence patterns 406, and clause patterns 410 may be part of the narrative part selection rules. As a result, the administrator needs only to enter data relevant to the narrative parts 412 to complete the narrative template. Generation of the narrative and the clinical note based upon a completed patient measure and the rules outlined in the user interface 400 are discussed in greater detail below with respect to FIGS. 6A-6B.

In further embodiments, patient responses provided in the patient measure may be scored. For example, the note generation system 102 may further include a formula editor (e.g., as a component of the rules generation module 120 or another module or component of the note generating system 102). An administrator, using his or her administrator computing device, may enter formulas in the formula editor to describe how to generate numerical scores when a patient fills out a patient measure.

Returning again to FIG. 2, in block 206 of process 200, a patient measure according to blocks 202 and 204 may be exposed to the patient for completion by the patient response module 122. The patient response module 122 may be configured to ensure that a patient communicating with the clinical note generating system 102 is identified and provided with the correct patient measures for completion. The patient response module 122 may perform functions to validate a patient's identity through authorization procedures known in the art, including but not limited to one or more of login authentication (e.g., username/passwords), security keys, and the like.

Upon confirming the identity of the patient, the patient response module 122 may provide a user interface 500 which displays a patient measure 502 for completion by the patient (FIG. 5). Optionally, the user interface 500 may include selection options (not illustrated) allowing the patient to select a patient measure in the circumstance where multiple patient measures are to be completed by the patient. For example, continuing the example above with respect to FIGS. 3A-3B, the patient may select radio buttons 504 displayed in the patient measure 502 to indicate their responses.

After completing the patient measure 502, the patient may select user interface object 506 to save the completed template 502 to the data store 112 for subsequent use in generating a clinical note based upon the completed patient measure 502. When saving the completed response, the patient response module 122 may store a data structure which maps the element IDs of the patient measure to the patient's entered values. If the patient has not entered an answer for an element, the data structure will not include an entry for that element.

For example, when the patient hits the user interface object 506 to save the patient measure, the data they entered is sent to the patient response module 122 as part of an HTTP POST request. The patient response module 122 may receive this data as text and de-serialize the data into a dictionary data structure of element IDs to patient choices which is stored in a database. For multiple-choice elements, the patient choice may be represented as a choice ID of the choice set. Thus, with reference to FIG. 3A, the patient choice “Not at all” is represented by the choice ID 1, the patient choice “Several days” is represented by the choice ID 2, and so forth. For other input elements, the patient choice may be represented by the text entered by the patient.

Returning again to FIG. 2, in block 210 of process 200, a draft clinical note is generated for the patient measure by the note creation module 124 for review and approval by a clinician. For example, the clinician, employing his or her clinician computing device 106, may communicate with the note creation module 124 via a user interface which enables the administrator to review, edit, and approve the clinical note for the patient measure. The note creation module 124 may be configured to ensure that a clinician communicating with the clinical note generating system 102 is identified and provided with the correct clinical notes. The note creation module 124 may also perform functions to validate a clinician's identity through authorization procedures known in the art, including but not limited to one or more of login authentication (e.g., username/passwords), security keys, and the like.

Upon confirming the identity of the clinician, the note creation module 124 may provide user interfaces 600, 650 which display the completed patient measure 602 and a draft clinical note 656 corresponding to the patient measure 602. For example, the patient measure 202 may display checkmarks 604 to indicate which response option chosen by the patient in their response. Optionally, the user interface 600 may include selection options (not illustrated) allowing the clinician to select different patients and patient measures in the circumstance where multiple clinical notes are to be completed by the clinician.

Returning to FIG. 2, when generating the narrative 656, the note creation module 124 process a plurality of blocks 210A-210E. For example, in block 210, the note creation module 124 retrieves the applicable rules (e.g., global narrative rules, narrative combination rules and rules stored in the narrative template for the patient measure in FIG. 4) and the stored data representing the patient's choices as described above with respect to FIG. 5.

In block 210B, a list of selected narrative parts is generated based upon the patient response data and the narrative parts specified in the narrative template. The output of block 210B is the subset of narrative parts defined in the narrative template 402 which apply to the patient response data. For example:
1. Start with a list set of narrative parts from the narrative template.
2. For each narrative part selection rule in the narrative:
   a. If the patient response includes a patient entered value that matches a rule's element ID and, if a set, the rule's choice ID.
   b. —or—if the element corresponding to this rule is a multiple choice input element and the rule is for the “not answered” case and the patient response does not include a patient entered value for the corresponding element;
   c. —then—the narrative part referenced by this rule in the list of selected narrative parts is included in the list of returned narrative parts.
      After each narrative part selection rule has been so considered, the list of narrative parts which apply to the patient response data is returned.

For example, assume that the list of narrative parts 412 of FIG. 4 corresponds to Question 1 of the patient measure and that the patient response to Question 1 is “Not at all.” Following the process discussed above with respect to block 210B, the starting list set of narrative parts is narrative parts 412. Since the patient response is for the patient measure having an element ID matching the rules in the narrative template 402 (i.e., 1340), and the choice ID corresponding to the patient entered value, “Not at all” (i.e., 0) matches the choice ID of row 1 (index 1) of the narrative parts 412, the narrative parts referenced by this rule are including in the list of returned narrative parts.

Returning to FIG. 2, after the narrative part selection rules have been used to select the narrative parts that apply to the patient response data in block 210B, one or more narrative combination rules may be applied to the selected parts in block 210C in order to combine subsets of the selected parts into a single narrative part that may be more naturally comprehended by a reader. For example, given a patient measure with five questions, five narrative parts may be returned (e.g., one for each question) after the narrative part selection rules are executed. Using one or more narrative part combination rules; these five, perhaps disjointed, narrative parts may be combined into a single, perhaps more cohesive and readily understood, new narrative part.

In one embodiment, the narrative combination rules 414 comprise a list or group of tags that identify narrative parts as shown in FIG. 4. More specifically, the group of tags may identify a set of one or more narrative parts upon which a narrative combination rule is applied. As also shown in FIG. 4, each narrative combination rule 414 may also have a replacement snippet, which defines how a set of selected narrative parts is combined into a new (single) narrative part. For example,
1. Start with the narrative parts selected by the narrative part selection rules (call this set NP);
2. For each narrative combination rule:
   a. identify a subset of the narrative parts having a tag that is a target of the narrative combination rule;
   b. group the subset of narrative parts by paragraph, clause pattern, sentence pattern, and group tab (call this grouping NPg);
   c. for each group of narrative parts G1 from NPg:
      i. remove all narrative parts in G1 from the original set NP.
      ii. if multiple narrative parts exist in G1 with the same tag, break G1 into multiple subsets of narrative parts (call these subsets G2) where each subset has at most one narrative part of each tag (call this grouping of multiple subsets of narrative parts SG1);
      iii. otherwise, let SG1 be a set just containing G1;
   d. for each subset of narrative parts G2 in SG1 (if any), combine the narrative parts of the subset G2 into a new, single narrative part based on the same paragraph, sentence pattern, and clause pattern of the narrative parts of the subset G2, a minimum order weight of the narrative parts of the subset G2, and the replacement snippet for the narrative combination rule; and
   e. add the new narrative part to NP.

After each narrative part combination rule has been so considered, the list of narrative parts which apply to the patient response data is returned.

In block 210D, given the list of narrative parts returned in block 210C, each narrative part's paragraph template, sentence pattern, and clause pattern is examined and grouped into a hierarchy structure. In this hierarchy, paragraph groups form the root. Each paragraph group includes an ordered list of all narrative parts that belong to that paragraph, either a narrative part or sentence group. Next in the hierarchy comes the sentence group, which is an ordered list of narrative parts that all belong to the same sentence (and implicitly in the same paragraph group) selected from individual narrative parts and clause groups. Following the sentence groups in the hierarchy are the clause groups. Each clause group includes an ordered list of all narrative parts that belong to the same clause (and implicitly in the same sentence and paragraph). For example:
1. Create an empty list of paragraph grouping objects. Call this PG.
2. For each paragraph template in the narrative template 402, group all of the narrative parts from the input that use the paragraph template together in order of how they appear in the narrative template 402.
3. For each group of narrative parts in a single paragraph template:
   a. Those narrative parts that also share the same sentence pattern are grouped together.
   b. For those narrative parts which do not have a sentence pattern but still use this paragraph template, groups are formed that contain just one narrative part each.
   c. The groups formed according to a and b are combined and ordered. For the purpose of ordering, the minimum order weight listed in the narrative parts 412 is selected for comparison with other groups. Call the ordered list of groups G.
   d. Create an empty list of narrative part and sentence groups. Call this list SG.
   e. For each group of narrative parts in Gₛ:
      i. If the group does not have a shared sentence pattern, add it to SG as an individual narrative part.
      ii. Otherwise, further group the narrative parts in this group into sub-groups that share the same clause pattern.
      iii. For those narrative parts which do not have a clause pattern, form sub-groups that contain just one narrative part each.
      iv. Combine and order the groups formed according to i/ii and iii as discussed above in c. Call this combined and ordered list of sub-groups G_{c}.
      v. Create an empty list of narrative part and clause group objects. Call this CG.
      vi. For each sub-group of narrative parts in G_{c}:
         1. If the group does not have a shared clause group, add it to CG as an individual narrative part.
         2. Otherwise, create a clause group with all narrative parts in the group and the shared clause pattern (that each narrative part uses) and add this to CG.
      vii. Add a new sentence group with CG as its list of narrative parts and clause groups and the shared sentence pattern to SG.
   f. Add a new paragraph grouping with its list of narrative part and sentence groups to SG and with the paragraph template from above to SG.
4. Return the list PG as an intermediate grouping data structure.

Continuing the example above with respect to all patient measure Questions for which the patient has responded “Not at all.” Further assume that the patient has also responded “Not at all” to Questions 5 and 6 of the patient measure (see FIG. 5) and that the corresponding rows of the narrative parts for Questions 5 and 6 contain the same information as that of row 1 of narrative parts 412, with the exception that, instead of reading “interest,” the snippets are “appetite” and “self-esteem,” respectively. Thus the returned narrative parts for row 1 of narrative parts 412 and the appropriate rows of Questions 5 and 6 share the same paragraph template (1), sentence pattern (1), and clause pattern (3). Accordingly, these narrative parts are combined together and ordered according to their respective weight. Assume that the narrative parts are ordered Question 1, Question 5, and Question 6.

Questions 1, 5, and 6 share the same sentence and clause pattern and belong to paragraph index 1 (i.e., the second paragraph of the narrative text). Accordingly, the narrative lists of Questions 1, 4, and 5 are grouped together. The shared sentence pattern for these questions is 1, which corresponds to index 1 of sentence patterns 406. Index 1 of sentence patterns 406 indicates the prefix “The patient denied having problems with” and the suffix “over the past two weeks.” The shared clause pattern for these questions is 3, which corresponds to index 3 of clause patterns 410. Index 3 of clause pattern 410 indicates no clause prefix or suffix. Thus, for Questions 1, 5, and 6 the list PG contains the prefix “The patient denied having problems with” and the suffix “over the past two weeks” as an intermediate grouping data structure. 100511 In block 210C, the intermediate grouping data structure is used to output the narrative as text by walking through the hierarchy of paragraphs, sentences, and clauses and building the narrative with new text at each step. For example:
1. Create an empty text object. Call this object T.
2. For each paragraph group in the narrative that has narrative parts or whose paragraph template is marked as “always render:”
   a. If there was a prior paragraph added to T, add an extra line of spacing.
   b. If the paragraph template has a starting sentence, add it to T.
   c. For each item in the list of narrative parts and sentence groups in the paragraph group:
      i. If the item is a narrative part, add the part's snippet to T as the complete sentence.
      ii. Otherwise, if the sentence group's sentence pattern has a prefix, start a new sentence with that prefix.
      iii. For each item in the list of narrative parts and clause groups in the sentence group:
         1. If the item is a narrative part, add the part's snippet to the sentence as a complete clause.
         2. Otherwise, if the clause group's clause pattern has a prefix, start a new clause with that prefix.
         3. Add the snippet of each narrative part in the clause group to the new clause.
         4. Separate multiple snippets in the same clause with a conjunction “and” if there are two or, if there are more than two, with commas and the last two snippets are separated with “and.”
         5. If the clause pattern has a suffix, close the clause with that.
      iv. Separate multiple rendered clauses in the same sentence with “and” if there are two or, if there are more than two, with commas and the last two clauses are also separated with “and.”
      v. If the sentence pattern has a suffix, close the sentence with the suffix.
      vi. Add the sentence to T.
   d. If the paragraph template has an ending sentence, add it to T.
3. Output T as the result.

Continuing the example above in block 210D using the intermediate grouping data structure, text is generated for Questions 1, 4, and 5. The sentence is started with the prefix “The patient denied having problems with.” The snippets interest, appetite, and self-esteem are added after the prefix, with commas separating interest and appetite and “and” separating appetite and self-esteem (e.g., “interest, appetite and self-esteem”). The sentence is closed with the suffix, “over the past two weeks.” Thus, the narrative corresponding to Questions 1, 4, and 5 of the patient measure is displayed in the second paragraph of the narrative text and reads, “The patient denied having problems with interest, appetite and self-esteem over the past two weeks,” as illustrated in FIG. 6B.

In further embodiments, the note creation module 124 may further generate numerical scores for the completed patient measure based upon the formulas provided in the formula editor.

In block 210E, the text output from block 210D may be combined with the patient response and displayed to the clinician, as discussed above. Any scores generated by the note creation module 124 may also be displayed. FIG. 6B illustrates one embodiment of the generated numerical score 654 and narrative text 656.

The draft clinical note represented in FIGS. 6A-6B may be reviewed, edited, and/or approved by the clinician. For example, selection of user interface object 652 may enable the clinician to edit the patient responses indicated in the completed patient measure 602. For example, such editing may be appropriate if the patient has forgotten to enter a response and later conveys this response to the clinician (e.g., verbally during a consultation). In the circumstance where the clinician edits the patient's response, the clinical note 656 generated in blocks 210A-210E may be updated to reflect this change.

In decision block 212 of the process 200, the clinician may choose to accept or edit the clinical note on review of the clinical notes 656. To accept the clinical note 602 as displayed in the user interfaces 600, 650 without edits, the clinician may select an accept user interface object 660 without making changes to the draft narrative 656. Alternatively, the clinician may select the draft narrative 656 and enter their desired changes in block 214. Selection of an edit user interface object 660 may save these changes within the draft clinical note 602. Subsequently, the clinician may accept the revised clinical note 602 displayed in the user interfaces 600, 650 by selecting select the accept interface object 660.

All of the processes described herein may be embodied in, and fully automated via, software code modules executed by one or more general purpose computers or processors. The code modules may be stored in any type of computer-readable medium or other computer storage device. Some or all the methods may alternatively be embodied in specialized computer hardware. In addition, the components referred to herein may be implemented in hardware, software, firmware or a combination thereof.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Thus, such conjunctive language is not generally intended to imply that certain embodiments require at least one of X, at least one of Y and at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A system for generating clinical notes comprising:
a data storage device configured to store a plurality of clinical measures, a plurality of responses to at least one of the plurality of clinical measures, and rules for generating clinical note narratives; and
a computing device in communication with the data store, the computing device configured to at least:
retrieve at least one patient or physician response from the data store;
retrieve the rules for generating clinical note narratives maintained by the data store;
automatically generate a draft text narrative based at least in part on the retrieved patient or physician response and rules; and
store the retrieved patient or physician response and the draft text narrative in association with a patient file.

2. The system of claim 1, wherein the responses are from a patient or a physician of the patient.

3. The system of claim 1, wherein the plurality of clinical measures each comprise at least one question, survey, physiological observation, or symptom.

4. The system of claim 1, wherein the computing device is further configured to display the draft text narrative to an authorized user for at least one of review, approval or editing.

5. The system of claim 2, wherein the computing device is further configured to permit editing of the patient or physician response by the authorized user.

6. The system of claim 3, wherein the computing device is further configured to update the draft text narrative according to the edited response.

7. The system of claim 2, wherein the computing device is further configured to permit editing of the draft text narrative by the authorized user.

8. The system of claim 5, wherein the computing device is further configured to permit acceptance of the draft text narrative edited by the authorized user.

9. The system of claim 1, wherein the rules comprise a narrative template describing paragraph templates, sentence patterns, and clause patterns for use in generating the narrative text in combination with the patient responses and wherein the paragraph templates, sentence patterns, and clause patterns are organized according to one or more narrative parts included in the narrative template.

10. The system of claim 7, wherein the rules further comprise one or more combination rules that combine multiple narrative parts into a single narrative part.

11. The system of claim 1, further comprising a user interface for patient completion of clinical measures.

12. They system of claim 1, further comprising a user interface for review and/or editing of generated draft narratives by an authorized user.

13. A computer-implemented method of generating clinical notes comprising:
under control of a computing device configured with specific computer-executable instructions,
receiving data representing a response to a clinical measure regarding a condition of a patient, the clinical measure comprising at least one question, survey, physiological observation, or symptom;
retrieving rules for generating clinical note narratives from an electronic data store;
automatically generating a draft narrative based at least in part on the patient or physician response and the rules; and
causing presentation of the draft narrative on a display of an electronic device.

14. The computer-implemented method of claim 13, wherein the presentation of the draft narrative includes presentation of the response with the draft narrative.

15. The computer-implemented method of claim 13, further comprising storing a reviewed draft narrative in the electronic data store in association with the patient.

16. The computer-implemented method of claim 15 further comprising:
receiving edits to the draft narrative;
automatically generating an edited narrative; and
storing the edited narrative in the electronic data store in association with the patient.

17. The computer-implemented method of claim 13, wherein the rules comprise a narrative template describing paragraph templates, sentence patterns, and clause patterns for use in generating the narrative text in combination with the patient responses and wherein the paragraph templates, sentence patterns, and clause patterns are organized according to one or more narrative parts included in the narrative template.

18. The computer-implemented method of claim 17, wherein the rules further comprise one or more combination rules that combine multiple narrative parts into a single narrative part.

19. A non-transitory computer readable medium storing instructions for operating a clinical note generation system which, when executed, causes a processor to at least:
retrieve a response to a clinical measure regarding a condition of a patient;
retrieve one or more rules for narrative generation;
automatically generate a draft narrative based at least in part on the retrieved response and the one or more rules; and
store the draft narrative in association with said patient.

20. The non-transitory computer readable medium of claim 19, wherein said instructions, when executed, further cause the processor to at least initiate presentation of the draft narrative on a display of a computing device.

21. The non-transitory computer readable medium of claim 20, wherein said instructions, when executed, further cause the processor to at least:
automatically generate an edited narrative based at least in part on an edit made to the draft narrative;
delete the draft narrative stored in association with said patient; and
store the edited narrative in association with said patient.

22. The non-transitory computer readable medium of claim 20, wherein said instructions, when executed, further cause the processor to at least verify that the edit is authorized.

23. The non-transitory computer readable medium of claim 19, wherein the rules comprise a narrative template describing paragraph templates, sentence patterns, and clause patterns for use in generating the narrative text in combination with the patient responses and wherein the paragraph templates, sentence patterns, and clause patterns are organized according to one or more narrative parts included in the narrative template.

24. The non-transitory computer readable medium of claim 23, wherein the rules further comprise one or more combination rules that combine multiple narrative parts into a single narrative part.

25. The non-transitory computer readable medium of claim 19, wherein the clinical measure comprises at least one question, survey, physiological observation, or symptom.

26. The non-transitory computer readable medium of claim 19, wherein the response is from at least one of the patient or a physician for the patient.
